(19) United States
(12) Patent Application Publication
(10) Pub. No.: US 2005/0288188 A1
(43) Pub. Date: Dec. 29, 2005

(54) Manufacture and use of a plant growth regulating compound

(75) Inventors: Greg Volgas, Bartlett, TN (US); Johnnie R. Roberts, Memphis, TN (US); Trey Baker, Horn Lake, MS (US); James Thomas, Cordova, TN (US)

Correspondence Address: CONNOLLY BOVE LODGE & HUTZ, LLP, P O BOX 2207, WILMINGTON, DE, 19899, US

(73) Assignee: HELENA HOLDING COMPANY, Wilmington, DE (US)

(21) Appl. No.: 11/167,729

(22) Filed: Jun. 27, 2005

Related U.S. Application Data
(60) Provisional application No. 60/583,353, filed on Jun. 28, 2004.

(51) Int. Cl. A01N 57/18; A01N 43/36; A01N 43/16; A01N 25/04; A01N 25/16

(52) U.S. Cl. 504/284; 504/292; 504/363

(57) ABSTRACT

The invention pertains to a method for manufacture and use of a formulation of plant growth regulating acids. A number of different solvents have been found useful in this application. Furthermore, the use of surfactants that act as solvents for the acid plant growth regulators has been discovered.

### RELATED APPLICATIONS

This application claims benefit to provisional application No. 60/583,353 filed Jun. 28, 2004 which is incorporated by reference in its entirety for all useful purposes.

### FIELD OF INVENTION

The invention pertains to a method for manufacture and use of a formulation of plant growth regulating acids.

### BACKGROUND OF THE INVENTION

Many agricultural formulations contain plant growth regulators (PGR's) in their acid form. One such formulation of PGR's involves dissolving gibberellic acid or indole butyric acid in water. The disadvantage of these formulations is that the PGR is often unstable in aqueous solutions. The breakdown of the active PGR substances results in either poor product performance or expiration dates on the product.

Another common way to avoid the decomposition of PGR's in water is to dissolve these actives in alcohol. Isopropanol is commonly used as the solvent. The disadvantage of this approach is that the resulting formulation is highly flammable, creating storage and safety issues for users.

It would be preferable, then, to apply the plant growth regulators in a non-flammable formulation and also to provide active ingredient stability.

Surfactants are used in most agricultural formulations to enhance the ease of application. Many pesticide formulations use hydrophobic solvents, requiring the use of surfactants to emulsify the hydrophobic solvent and pesticide into water. Surfactants have also been used both as adjuvants and formulation components to enhance the effectiveness and spreading ability of applied sprays.

### SUMMARY OF THE INVENTION

We have surprisingly discovered that many plant growth regulating acids can be dissolved into surfactants. These surfactant solubolized plant growth regulators are then seen to have improved storage stability. They are also no longer flammable, with flash points over 200 degrees F.

One embodiment of the invention is a plant growth regulator composition comprising at least one acid plant growth regulator and at least one surfactant in an effective amount such that said acid plant growth regulator is dissolved in the surfactant and said at least one surfactant is present in a quantity equal to or greater than said at least one acid plant growth regulator.

The invention also related to a process to produce a composition which comprises blending a fully solubolized acid plant growth regulator with a surfactant to form a solution provided that said acid plant growth regulator and surfactant are present in an amount of about 1 part by weight of acid plant growth regulator to at least about 1.5 part by weight of surfactant.

### DETAILED DESCRIPTION OF THE INVENTION

Again, one embodiment of the invention is a plant growth regulator composition comprising at least one acid plant growth regulator and at least one surfactant in an effective amount such that said acid plant growth regulator is dissolved in the surfactant and said at least one surfactant is present in a quantity equal to or greater than said at least one acid plant growth regulator.

Another embodiment of the invention is a plant growth regulator composition comprising at least one fully solubolized acid plant growth regulator and at least about 8 weight % of at least one surfactant.

The invention also related to a process to produce a composition which comprises blending a fully solubolized acid plant growth regulator with a surfactant to form a solution provided that said acid plant growth regulator and surfactant are present in an amount of about 1 part by weight of acid plant growth regulator to at least about 1.5 part by weight of surfactant.

Plant growth regulating acids include, but are not limited to the acid forms of:

Synthetic auxins including, but not limited to:

Indole acetic acids

Indole butyric acids

Giberrelic acids

Naphthalene acetic acids

Cytokinins

Abscisic acid

Useful surfactants or solvents include but are not limited to:

Alcohol alkoxylates including but not limited to:

Based on branched and linear alcohols

Those containing ethylene oxide or propylene oxide

Alcohol alkoxylate sulfates,

Alkylphenol alkoxylates including but not limited to:

Nonylphenol and octylphenols.

Those containing ethylene oxide or propylene oxide

Alkanolamides,

Alkylaryl sulfonates,

Amine oxides

Amines including but not limited to:

Fatty amine alkoxylates such as but not limited to tallowamine alkoxylates,

Betaine derivatives,

Block polymers of ethylene and propylene glycol,

Carboxylated alcohol or alkylphenol alkoxylates,

Diols, including but not limited to Butanediols,

Diphenyl sulfonate derivatives,

Ethers, including but not limited to

Butyl cellulose,

Butyl carbitol,

Ethoxylated amines,

Ethoxylated fatty acids,

Ethoxylated fatty esters and oils,

Ethylene carbonate,

Fatty esters,

Glycerol esters,

Glycols including but not limited to

Propylene glycol,

Ethylene glycol,

Dipropylene glycol,

Diethylene glycol,

Phosphate ester surfactants including but not limited to

Phosphate esters of alcohol alkoxylates,

Phosphate esters of alkylphenol alkoxylates,

Propylene Carbonate,

Sarcosine derivatives,

Silicone-based surfactants,

Sorbitan derivatives including but not limited to:

Sorbitan esters,

Alkoxylated sorbitan esters,

Sucrose and glucose derivatives including but not limited to:

Alkylpolyglucosides,

Sulfates and sulfonates of alkoxylated alkylphenols,

Sulfates of alcohols,

Tristyrylphenol Alkoxylates,

Other surfactants are disclosed in McCutcheon's Emulsifiers and Detergents, North American Edition, 2000.

Other surfactants are disclosed in the following patents:

U.S. Pat. No. 5,741,502 Homogeneous, essentially nonaqueous adjuvant compositions with buffering capability

U.S. Pat. No. 5,725,630 Dry granular fertilizer blend and a method of fertilizing plants

U.S. Pat. No. 5,580,567 Homogeneous, essentially nonaqueous adjuvant compositions with buffering capability

U.S. Pat. No. 5,393,791 Homogeneous, essentially nonaqueous adjuvant compositions with buffering capability

U.S. Pat. No. 5,234,919 Water soluble, highly active dimethoate formulations in an alcohol/ester solvent system

U.S. Pat. No. 5,178,795 Homogeneous, essentially nonaqueous adjuvant compositions with buffering capability

U.S. Pat. No. 5,906,961 Alkanolamide spreader-sticker surfactant combination

U.S. Pat. No. 5,877,112 Agricultural formulation

U.S. Pat. No. 6,232,272 Manufacture and use of plant growth regulator chlorinated phenoxy formulation

The formulations may also contain oil-based components.

The oil or oil substitutes include, but are not limited to:

Alkylated fatty acid esters, include but are not limited to:

Methylated fatty acids, include but not limited to:

Methylated C6-C19 fatty acids,

Methylated Tall oil fatty acids,

Methylated Oleic acid,

Methylated Linoleic acid,

Methylated Linolenic acid,

Methylated Stearic acid,

Methylated Palmitic acid,

And blends thereof;

Ethylated fatty acids, include but are not limited to:

Ethylated C6-C19 fatty acids,

Ethylated Tall oil fatty acids,

Ethylated Oleic acid,

Ethylated Linoleic acid,

Ethylated Linolenic acid,

Ethylated Stearic acid,

Ethylated Palmitic acid,

And blends thereof;

Butylated fatty acids, include but are not limited to:

Butylated C6-C19 fatty acids,

Butylated Tall oil fatty acids,

Butylated Oleic acid,

Butylated Linoleic acid,

Butylated Linolenic acid,

Butylated Stearic acid,

Butylated Palmitic acid,

And blends thereof;

Alkylated natural oils, include but are not limited to:

Alkylated soybean oil, include but limited to:

Methylated soybean oil,

Ethylated soybean oil,

Butylated soybean oil,

And blends thereof;

Alkylated canola oil, include but are not limited to:

Methylated canola oil,

Ethylated canola oil,

Butylated canola oil,

And blends thereof;

Alkylated coconut oil, include but are not limited to:

Methylated coconut oil,

Ethylated coconut oil,

Butylated coconut oil,

And blends thereof;

Alkylated sunflower oil, include but are not limited to:

Methylated sunflower oil,

Ethylated sunflower oil,

Butylated sunflower oil,

And blend thereof;

Hydrocarbon oils include but are not limited to:

Mineral oils, including but are not limited to:

Paraffinic mineral oils,

Naphthenic mineral oils,

Aromatic mineral oils,

And blends thereof;

Vegetable oils, include but are not limited to:

Soybean oil,

Canola oil,

Cottonseed oil,

And blends thereof;

Fatty acids, include but are not limited to:

C6-C19 fatty acids,

Tall oil fatty acids,

Oleic acid,

Linoleic acid,

Linolenic acid,

Stearic acid,

Palmitic acid,

And blends thereof;

Polybutenes

Epoxified seed oils include but are not limited to:

Epoxified soybean oil and

Other oils or oil substitutes

The formulation can contain at least one of the above oils or its equivalent. The oil can also be a blend of at least two oils. When oil is used in the formulation, a surfactant or emulsifier must also be used if the composition is intended for aqueous based sprays.

The composition preferably contains

(a) from about 1 to about 50% by weight of at least one acid plant growth regulator, preferably about 1 to about 10% and most preferably about 1 to about 5% and

(b) at least about 8% of a surfactant and preferably at least 10% by weight of a surfactant, more preferably at least 20% by weight of a surfactant, more preferably at least 30% by weight of a surfactant and even more preferably from at least 40% by weight of a surfactant and most preferably at least 50% by weight of a surfactant. Again the surfactant can be present in an amount from about 8 to about 99%, preferably about 50 to about 90%, and most preferably about 95 to about 98% and

(c) Optionally other components.

The plant growth regulator composition can optionally contain an aromatic solvent. The aromatic solvent is present preferably in an amount of at most 50% by weight and more preferably at most 40% by weight of an aromatic solvent and even more preferably at most 30% by weight of an aromatic solvent and even more preferably at most 20% by weight of an aromatic solvent and even more preferably at most 15% by weight of an aromatic solvent and even more preferably at most 10% by weight of an aromatic solvent and most preferably at most 5% by weight of an aromatic solvent.

The plant growth regulator composition preferably contains an acid plant growth regulator and a surfactant in the ratio of acid plant growth regulator to surfactant from about 1:6 to about 1:1.

The plant growth regulator composition does not need to contain an alkylated fatty acid, alkylated plant derived oil and/or an alkylated animal derived oil.

Examples of these formulations are shown below:

### EXAMPLE 1

| | |
|---|---|
| Gibberellic acid | 2.0% |
| PEG 200 | 49.0% |
| Tallow amine ethoxlate (15 EO) | 49.0% |

In all of the above examples, the components are blended together and the technical dissolved entirely. The solution formed contains less than 2% of precipitates and preferably 0% precipitates.

Various additions can be made to the compositions as one may anticipate based on skill in the art. Pesticides could be formulated using this composition. Fertilizers could be added to these compositions.

All references discussed herein are incorporated by reference in their entirety for all useful purposes.

1. A plant growth regulator composition comprising at least one acid plant growth regulator and at least one surfactant in an effective amount such that said acid plant growth regulator is dissolved in the surfactant and said at least one surfactant is present in a quantity equal to or greater than said at least one acid plant growth regulator.

2. The plant growth regulator composition as claimed in claim 1, wherein said surfactant is present in an amount from about 50 to about 90% by weight.

3. The plant growth regulator composition as claimed in claim 1, wherein said surfactant is present in an amount from about 70 to about 80% by weight.

4. The plant growth regulator composition as claimed in claim 1, wherein said acid plant growth regulator is present in an amount from about 1 to about 50% by weight.

5. The plant growth regulator composition as claimed in claim 3, wherein said acid plant growth regulator is present in an amount from about 1 to about 50% by weight.

6. The plant growth regulator composition as claimed in claim 1, which further comprises a solvent present in an amount at most 50% by weight.

7. The plant growth regulator composition as claimed in claim 5, which further comprises a solvent present in an amount at most 50% by weight.

8. The plant growth regulator composition as claimed in claim 1, wherein the composition contains less than 5% by weight of an alcohol.

9. The plant growth regulator composition as claimed in claim 7, wherein the composition contains less than 5% by weight of an alcohol.

10. The plant growth regulator as claimed in claim 1, wherein said acid plant growth regulator is a synthetic auxin.

11. The plant growth regulator composition as claimed in claim 10, wherein the synthetic auxin is
a. Indole acetic acids
b. Indole butyric acids
c. Giberrelic acids
d. Naphthalene acetic acids
e. Cytokinins, or
f. Abscisic acid.

12. The plant growth regulator composition as claimed in claim 9, wherein said acid plant growth regulator is
a. Indole acetic acids
b. Indole butyric acids
c. Giberrelic acids
d. Naphthalene acetic acids
e. Cytokinins, or
f. Abscisic acid.

13. A process to produce a plant growth regulating composition which comprises blending a fully solubolized acid plant growth regulator with a surfactant to form a solution provided that said acid plant growth regulator and surfactant are present in an amount of about 1 part by weight of acid plant growth regulator to at least about 1.5 part by weight of surfactant.

14. The plant growth regulator as claimed in claim 1, which further comprises at least one of the following additional components selected from the group consisting of
Methylated fatty acids,
Ethylated fatty acids,
Butylated fatty acids,
Alkylated soybean oil,
Alkylated canola oil,
Alkylated coconut oil,
Alkylated sunflower oil,
Mineral oils,
Vegetable oils,
Fatty acids,
Polybutenes and
Epoxified seed oils.

15. The plant growth regulator as claimed in claim 1, wherein the at least one surfactant is selected from the group consisting of
Alcohol alkoxylate,
Alcohol alkoxylate sulfate,
Alkylphenol alkoxylate,
Alkanolamide,
Alkylaryl sulfonate,
Amine oxide,
Amine,
Betaine derivative,
Block polymers of ethylene and propylene glycol,
Carboxylated alcohol or alkylphenol alkoxylate,
Diol,
Diphenyl sulfonate derivative,
Ether,
Ethoxylated amine,
Ethoxylated fatty acid,
Ethoxylated fatty ester and oils,
Ethylene carbonate,
Fatty ester,
Glycerol ester,
Glycol,
Phosphate ester surfactant,
Propylene Carbonate,
Sarcosine derivative,
Silicone-based surfactant,
Sorbitan derivative,
Sucrose derivative,
glucose derivative,
Sulfate of alkoxylated alkylphenol,
sulfonate of alkoxylated alkylphenol,
Sulfate of alcohol and
Tristyrylphenol Alkoxylate.
